(19) United States
(12) Patent Application Publication
(10) Pub. No.: US 2018/0347604 A1
(43) Pub. Date: Dec. 6, 2018

(54) LOCKING PANEL FASTENING DEVICE

(71) Applicants: Ned C. Bowers, Mount Dora, FL (US); Russell Ortner, Apopka, FL (US)

(72) Inventors: Ned C. Bowers, Mount Dora, FL (US); Russell Ortner, Apopka, FL (US)

(21) Appl. No.: 15/996,021

(22) Filed: Jun. 1, 2018

Related U.S. Application Data
(60) Provisional application No. 62/513,663, filed on Jun. 1, 2017.

(51) Int. Cl. F16B 5/02; F16B 5/10

(52) U.S. Cl. CPC F16B 5/0208; F16B 5/10; F16B 5/0258

(57) ABSTRACT

A fastener (300) for holding two panels together, including: a grommet (12) having a flange and an opening there through; an elongated pin (410) characterized by a pin longitudinal axis (442) along its length; a receptacle (404) having a central opening and female threads (602); an insert member (406) having two ramped bayonet slot arrangements (562) and male threads (560); and a pin receptacle (612) formed partly by a recess (610) in the female threads and partly in the insert member when the receptacle and the insert member align. In a first position (500) the pin does not occupy the recess in the female threads, thereby permitting relative rotation between the receptacle and the insert member. In a second position (640) the pin occupies the recess, thereby preventing the relative rotation between the receptacle and the insert member.

### FIELD OF THE INVENTION

The present invention relates to quick connect fasteners for holding panels together and, more particularly, to ¼ turn fasteners which can be fastened and unfastened quickly and repeatedly.

### BACKGROUND OF THE INVENTION

As can be seen from Prior Art FIG. 1, fasteners 10 of the ¼ turn type have been known which include a grommet 12, a stud 14 and a receptacle 16. The fastener 10 holds together two panels 18 and 20, with adjacent sides of the panels in contact with one another, by extending through openings 22 and 24 formed in the panels to receive the fastener. The grommet 12 has a cylindrical body 26 sized to extend through the opening 22 in one of the panels 18, usually an outer panel, and one end of the cylindrical body 26 has a radially outward extending flange 28 to engage the outer surface of the outer panel 18. The stud 14 has a shaft 30, a head 32, a cross pin 34 extending through the shaft at an end opposite to the head, a cup member 36 slidable along the shaft and a spring on the shaft between the head and cup member and received in the cup member. The stud 14 is received in the grommet 12, with the head 32 of the stud being adjacent to the flange 28 on the grommet and a radially outward extending flange 38 on the cup member 36 engaging a radially inward extending flange 40 at the end of the grommet 12 opposite to the radially outward extending flange 28. This arrangement keeps the head 32 of the stud 14 biased by the spring slightly outward from the radially outward extending flange 28 at the outer side of the outer panel 18. The cross pin 34 on the stud 14 prevents the assembly of the grommet 12 and the stud 14 from separating from the outer panel 18. Due to the presence of the cross pin 34 and the stiffness of the spring, a tool is required to move the cup member 36 adjacent to the head 32 by compressing the spring and thereby providing sufficient distance between the cross pin and the cup member that the stud can be inserted, at an angle, into the grommet. However, the geometry of this arrangement limits the axial length of the grommets 12 which can be used. Specifically, when the axial length of a grommet 12 reaches a certain magnitude, the stud 14 cannot be inserted into the grommet even when the cup member 36 is adjacent to the head 32.

The receptacle 16 of the fastener 10 has a generally cylindrical body 42 and a flange 44 projecting radially outward from one end of the body. The receptacle body 42 defines a central opening and has cam and locking surfaces 46 defined at an end opposite the radially outward extending receptacle flange 44. The receptacle flange 44 is placed against and secured to a side of the other panel 20, usually an inner panel, opposite to the side contacting the first panel 18, with the receptacle body 42 extending away from the side of the panel 20 to which the flange is attached. The panels 18 and 20 are brought together so that the stud 14 and the receptacle 16 are in alignment. The head 32 of the stud 14 is engaged by a turning tool, such as a screwdriver, pushed inwardly against the bias of the spring, and turned ¼ turn with the cross pin 34 of the 30 in engagement with the cam and locking surfaces 46 of the receptacle 16. This action locks the fastener 10 in place with the two panels 18 and 20 in secure engagement with one another.

A drawback of such a fastener is that, for a stud of any particular length, the total thickness of the two panels for which the fastener is effective must lie within a very limited range, typically a range of 0.030 inches. If the total thickness lies outside the range, a longer or shorter stud 14 must be used. If the total thickness lies outside the range by more than a full width of the range, a stud 14 two sizes longer than the first size must be used. Accordingly, for most work, a variety of stud sizes must be purchased and kept on hand.

The outer diameter of the cylindrical body of the grommet is sized to engage the surface defining the opening through the outer panel, so that lateral shifting of the outer panel with respect to the fastener is prevented. As the thickness of the outer panel increases, the length of grommet required increases. However, longer grommets have also required longer studs to enable the cross pin of the stud to pass through the longer grommets, at an angle.

U.S. Pat. No. 5,716,180 (the “'180 patent”), and U.S. Pat. No. 5,795,122 (the “'122 patent), which are incorporated herein by reference, each disclose fasteners that are adjustable to accommodate varying thicknesses of panels or different lengths of studs. Both the '180 patent and '122 patent disclose a fastener that includes an insert or “insert member” that is moveable relative to a receptacle mounted to one of the two elements that are fastened together. The insert has diametrically opposed cam and locking surfaces for receiving the above referenced stud and cross-pin. In addition, the insert has external threads that are sized to engage internal threads for rotating the insert and moving it relative to the receptacle thereby adjusting the distance between the grommet and locking surfaces. This may be advantageous if thickness of the panels vary.

The fasteners in the '180 patent and '122 patent also include a locking mechanism that fixes the insert against movement relative to the receptacle. The '180 patent discloses a compressible spring roll pin inserted into a slot formed by a groove on the outer periphery of the insert that is aligned with a groove on in internal surface of the receptacle. A second embodiment disclosed in the '180 patent refers to using a resilient member such as a nylon strip that is disposed in the grooves of the insert and receptacle. As disclosed the resilient member may take the form of an elongated member inserted in a groove formed on the external surface and threads of the barrel or insert member; or, the resilient member may take the form of a pellet inserted into a radial bore formed in the insert.

With respect to the '122 patent, there is disclosed a locking clip on an external surface of the receptacle. The locking clip is generally shaped like a “G” and made of a resilient material such as spring steel. The laterally disposed lip or locking member fits through a slot the receptacle and into a groove on the insert locking the insert against movement relative to the receptacle. While both fasteners provide advantages of an adjustable fastener, there are some disadvantages. One such disadvantage, at least with respect to the compression spring and locking pin, is that in order to access the locking mechanism for these fasteners one of the panels must be removed. In some cases, several or multiple fasteners may be in place and must be disengaged in order to remove the panel, which can be time consuming. Accordingly, existed a need for an adjustable fastener that has a locking mechanism that can be accessed without the need of removing panels during installation of the same.

In response, U.S. Pat. No. 7,997,843, which is incorporated herein by reference in its entirety, discloses an adjustable fastener that can be adjusted without removing the panels. As can be seen in Prior Art FIGS. 2-3, the pin 146 includes a recess 148 for receiving the engagement member 110 for unlocking the insert 96. As shown, the pin 146, includes at least two sections having differing diameters, including two end sections 150 having a diameter D1 that is greater than the diameter D2 of the recess 148. As shown, the locking mechanism 104 may be configured so the pin may be rotated in the slot 118 to move the recess 148 in and out of communication with the engagement member 110 and boring 112. As shown in FIG. 14, the pin 146 is oriented in the slot 118 so the recess 148 is not facing the boring 112. Accordingly, the pin 146 biases the engagement member toward and against the receptacle 56 at the groove 106 or 108, thereby locking the insert 96 in a fixed position relative to the receptacle 56.

In order to unlock the insert 96, the pin is simply rotated in the slot 118 in either a clockwise or counterclockwise direction, as shown in FIG. 15, so the recess 148, or a portion of the recess 148, faces the boring 112. In this manner, the engagement member 110 may move toward the pin 146 disengaging from the receptacle and unlocking the insert 96 to move the insert 96 relative to the receptacle 56. To prevent longitudinal movement of the pin 146 in the slot 118, a groove (not shown) may be machined around the pin 146 at the notch or recess 148, the engagement member may partially seat in the groove during adjustment. Similar to the above-described locking mechanism 104, including the pin 116, the slot 118 and pin 146 of this embodiment pin 146 disposed adjacent the central opening 100 of the insert 96 so one may adjust the insert without removing panels 58 or 60. An end 146A of the pin 146 may be adapted to receive a tool in order to rotate the pin 146.

This configuration provides several benefits. However, there is no positive association between the engagement member 110 and the pin 146 that positively disengages the engagement member 110 from the receptacle 56. Disengagement may thus require disturbing the fastener 50 until the engagement member 110 moves into the notch or recess 148, thereby disengaging the insert member 96 from the receptacle 56.

Accordingly, exists a need for an adjustable fastener that has a locking mechanism that positively disengages the insert member 96 from the receptacle 56.

### BRIEF DESCRIPTION OF THE DRAWINGS

The invention is explained in the following description in view of the drawings that show:

FIG. 1 is a cross section of a prior art fastener holding two panels together.

FIG. 2 is a cross section of another prior art fastener holding two panels together in a locked configuration.

FIG. 3 is a cross section of the prior art fastener of FIG. 2 holding two panels together in an unlocked configuration.

FIG. 4 is an exploded view of an example embodiment of a fastener disclosed herein.

FIGS. 5-8 show an example embodiment of a pin of the fastener of FIG. 4.

FIG. 9 shows assembled components of the fastener of FIG. 4.

FIG. 10 shows a pin in the receptacle of the fastener of FIG. 4.

FIG. 11 is a top view of the fastener of FIG. 4 in an unlocked configuration.

FIG. 12 is a cross-sectional closeup of the unlocked configuration of FIG. 11.

FIG. 13 is a bottom view of the pin and pin lock ring in the unlocked configuration of FIG. 11.

FIG. 14 is a top view of the fastener of FIG. 4 between the unlocked configuration and a locked configuration.

FIG. 15 is a bottom view of the pin and pin lock ring between the unlocked configuration and a locked configuration as shown in FIG. 14.

FIG. 16 is a side view of the pin and pin lock ring between the unlocked configuration and a locked configuration as shown in FIG. 14.

FIG. 17 is a top view of the fastener of FIG. 4 in a locked configuration.

FIG. 18 is a bottom view of the pin and pin lock ring in the locked configuration of FIG. 17.

FIG. 19 is a side view of another example embodiment of the insert member.

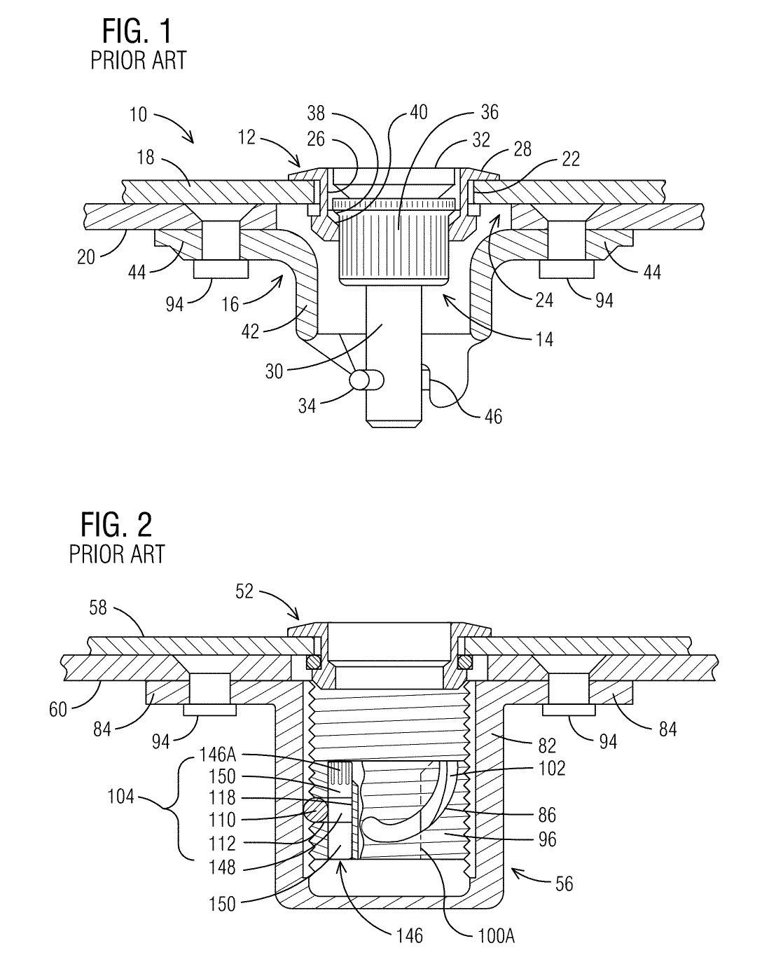

### DETAILED DESCRIPTION OF THE INVENTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

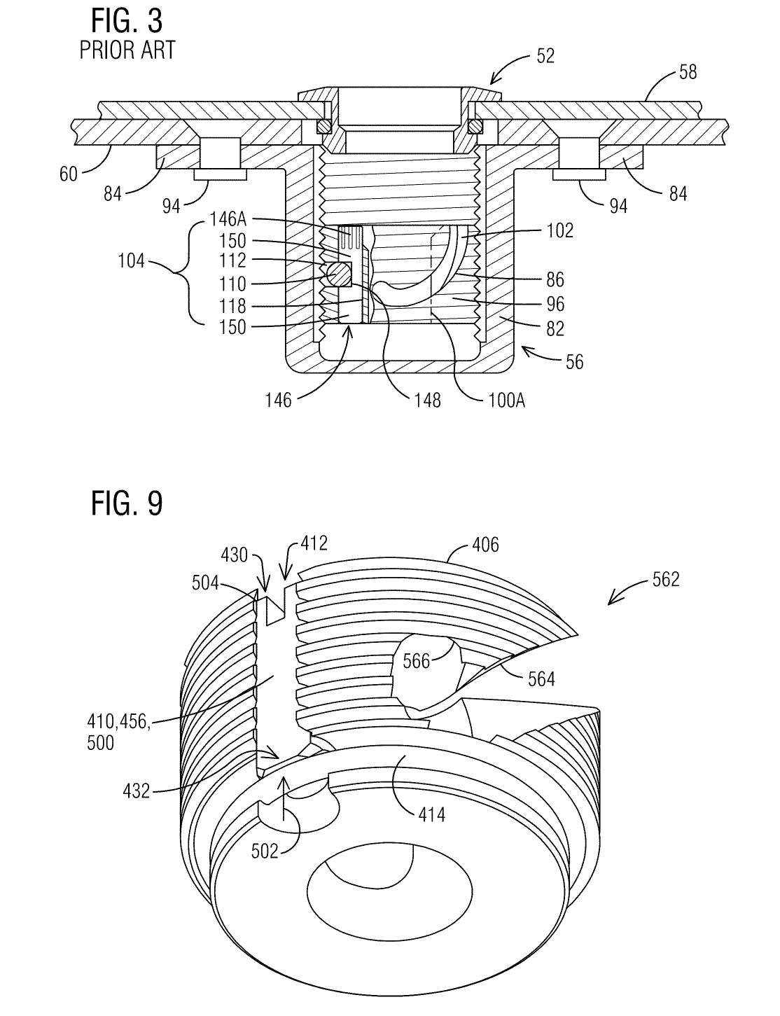

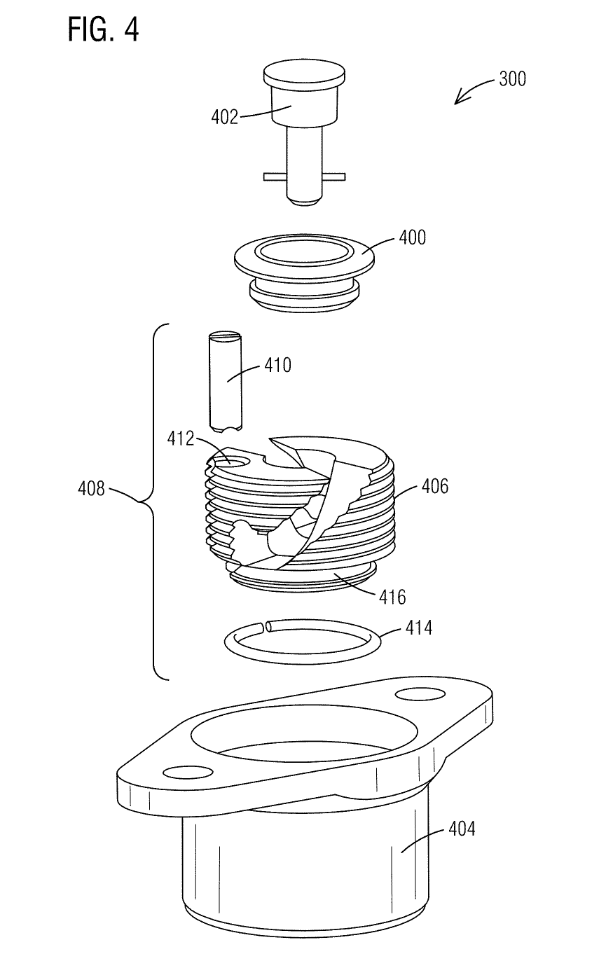

As can be seen from FIG. 4, the adjustable fastener 300 according to the present invention, is also of the ¼ turn type, the shown embodiment having a grommet 400, a stud 402, a receptacle 404, and an insert member 406. The fastener functions like the fastener 50 of FIGS. 2-3, but includes a new and innovative locking mechanism 408 to lock the insert member 406 into the receptacle 404. Elements of the shown embodiment of the locking mechanism 408 include a pin 410 that fits into an insert member recess 412 in the insert member 406, and a pin lock ring 414 that fits into a recess 416 in the insert member 406. Since the operation of the fastener 300 is known generally via, for example, the prior art references, discussion below focuses on the operation of the locking mechanism 408.

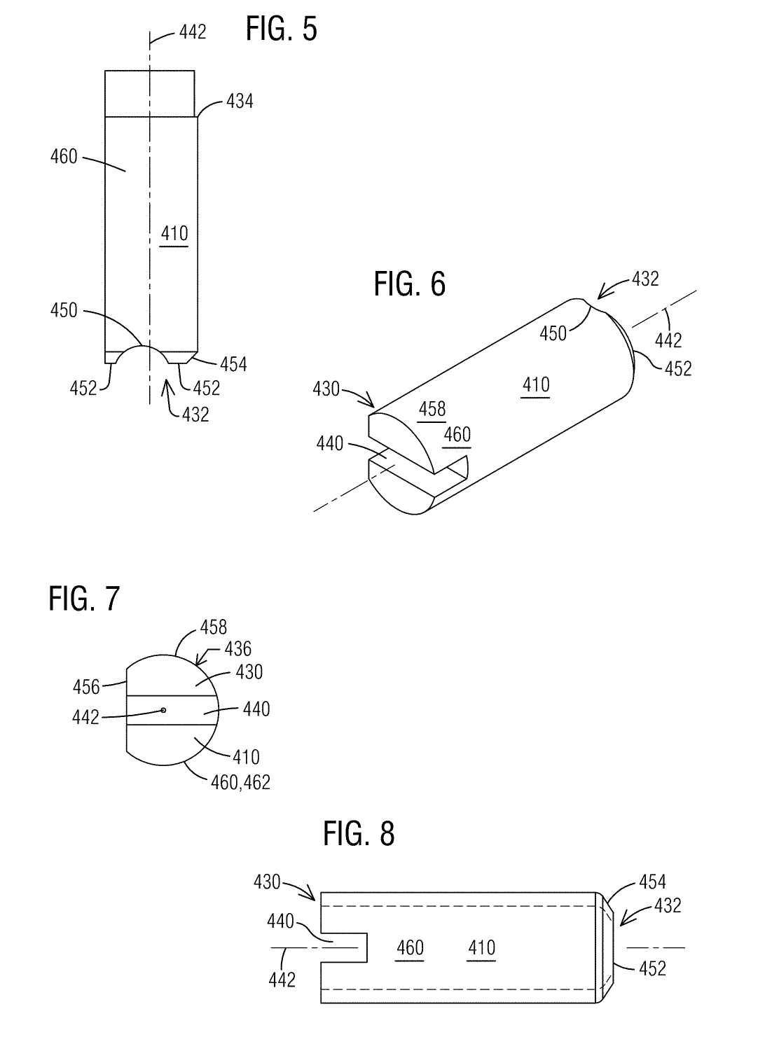

FIGS. 5-8 are various views of the example embodiment of the pin 410 having a top end 430 and a bottom end 432, and a generally cylindrical shape. In the example embodiment shown in FIG. 5, the pin 410 optionally includes a lip 434 (FIG. 5) that can cooperate with a ridge (not visible) in the insert member 406 to retain the pin 410 in the insert member recess 412. While the lip 434 is shown toward the top end 430, it could be located anywhere on the pin 410 so long as it cooperates with the ridge to retain the pin 410 in the insert member recess 412. Alternately, in the example embodiment shown in FIGS. 6-8, an outer diameter 436 of the pin 410 is sized to fit under the ridge and thereby be retained in the insert member recess 412. While the pin 410 is shown having a cylindrical shape, other shapes may be used, so long as the pin 410 can be retained in the insert member recess 412 and function as discussed below. For example, a cross section of the pin 410 may take on the shape of a “T” or the like.

The pin 410 may include a tool geometry 440 configured to engage a tool (not shown) used to rotate the pin 410 about a pin longitudinal axis 442 that extends a long a length 444 of the pin 410. In the example embodiment shown, the tool geometry 440 is a slot that can be engaged with, for example, a flat head screwdriver or the like. At the bottom end 432 the pin 410 may include a land 450 and one or more raised ridges 452. The land 450 may be embodied as a groove or any suitable shape that cooperates with the pin lock ring 414. Together, the land 450 and the raised ridge 452 cooperate with the pin lock ring 414 create a rotational interference that holds the pin in either a locked or an unlocked position, as will be discussed below. The pin 410 may also include one or more chamfers 454 that act as ramps for the pin lock ring 414 when the pin 410 is rotated.

The pin 410 further includes a flat surface 456 and a curved surface 458 in a side 460 of the pin 410. When rotated about the pin longitudinal axis 442, a larger diameter of the curved surface 458 acts as an eccentricity 462 relative to the flat surface 456, like a lobe on a cam. Different cross-sectional shapes of the pin 410 would result in differently shaped eccentricities, but this is acceptable so long as the pin 410 functions as described below.

FIG. 9 shows the insert member 406, the pin 410 disposed in the insert member recess 412, and the pin lock ring 414 disposed in the recess 416 which, in this example embodiment, is embodied as an annular groove. The pin 410 is in an unlocked position 500, (e.g. a first position) where the flat surface 456 faces radially outward. Stated another way, when in the locked position, the pin 410 takes a first clocking position about the pin longitudinal axis 442 with respect to the insert member 406. In a locked position the pin 410 will be in a second clocking position 180 degrees from the first clocking position. The pin lock ring 414 is positioned so that it abuts the bottom end 432 of the pin 410. A bias of the pin lock ring 414 exerts a force on the bottom end 432 of the pin in a direction 502 that is effective to press the pin 410 into the pin receptacle 612 and against a ridge 504 in the insert member 406 at the top end 430 of the pin 410. Consequently, the pin 410 is prevented from moving axially within the insert member recess 412, but is free to rotate in the insert member recess 412.

The insert member 406 includes male threads 560 that cooperate with female threads (not visible) on the receptacle 404 to advance the insert member 406 axially within the receptacle 404 as the insert member 406 is rotated. The insert member 406 further includes two ramped bayonet slot arrangements 562, each including a cam surface 564 and a locking surface 566 configured to engage a cross pin 34 of the stud 14 therein.

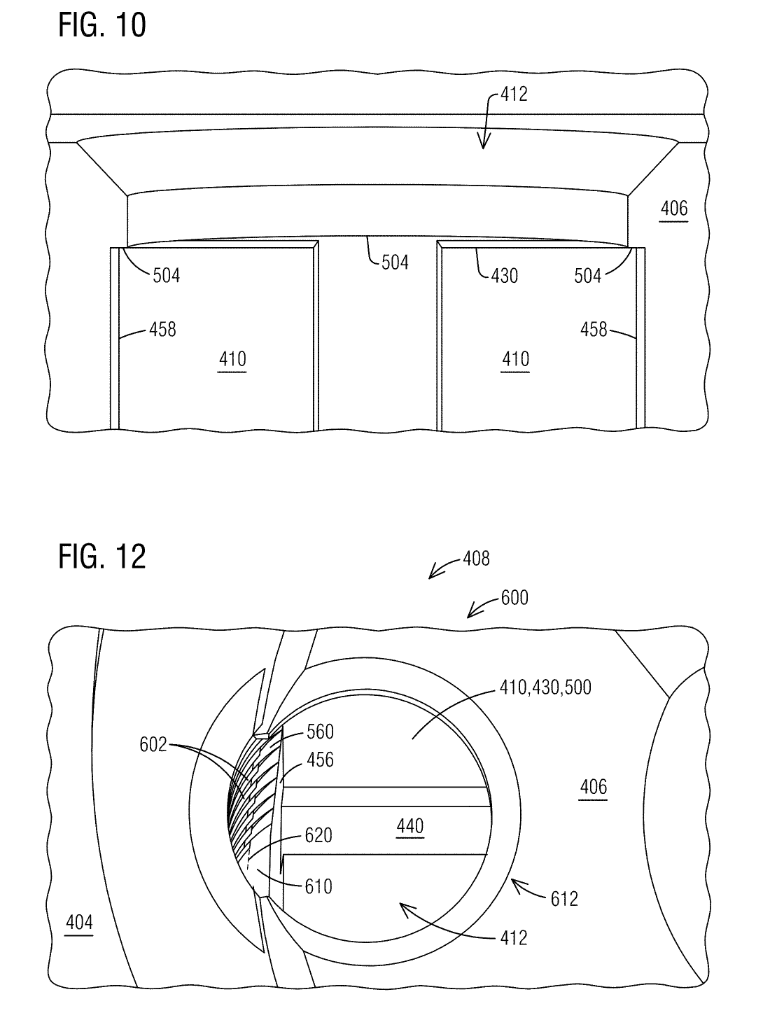

FIG. 10 is a cross-sectional closeup of the example embodiment of the insert member recess 412, showing the ridge 504 against which the pin 410 is pressed by the pin lock ring 414. Alternately, the ridge 504 could be located elsewhere to cooperate with a lip 434 (FIG. 5) on the curved surface 458 to retain the pin 410 in the insert member recess 412.

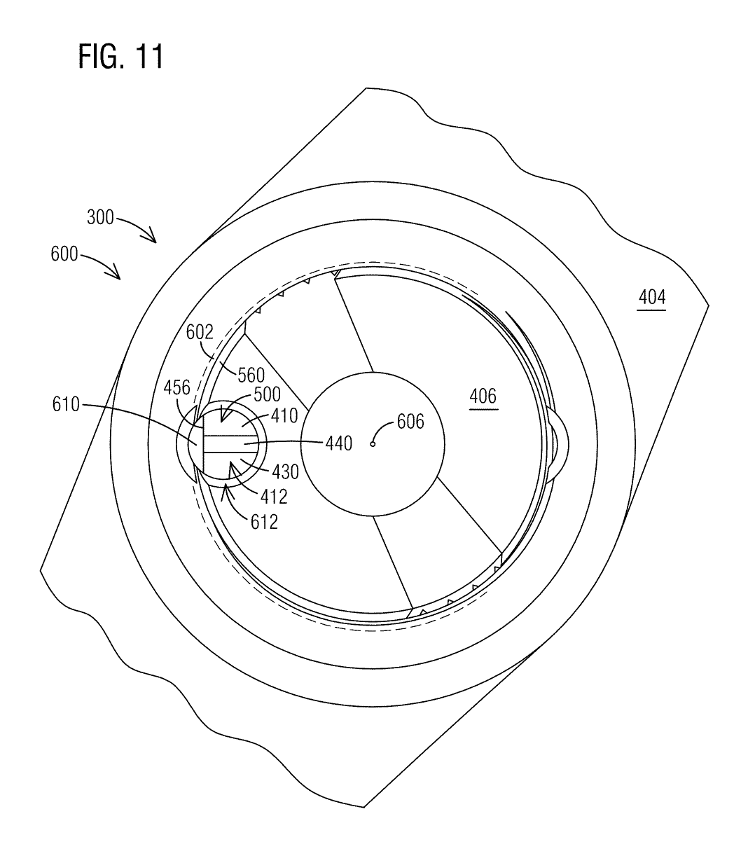

FIG. 11 is a top view of the fastener 300 with the pin 410 inserted into the insert member recess 412 and insert member 406 installed in the receptacle 404. The pin is in the unlocked position 500, and the fastener 300 is therefore in an unlocked configuration 600. The male threads 560 of the insert member 406 have engaged the female threads 602 of the receptacle 404 and the insert member 406 has been rotated a sufficient number of times to advance the insert member 406 along a receptacle longitudinal axis 606 to a desired location within the receptacle 404.

The receptacle 404 includes a receptacle recess 610 formed at least partly in the female threads 602 and having a boundary defined in part by a minor diameter of the female threads 602. When the receptacle recess 610 and the insert member recess 412 align, they together form a pin receptacle 612. Stated another way, then the insert member 406 assumes a particular clocking position (e.g. a first insert member clocking position) about the receptacle longitudinal axis 606, the receptacle recess 610 and the insert member recess 412 align to form the pin receptacle 612.

When the pin 410 is in the unlocked position 500, the entirety of the pin 410 resides within the insert member recess 412. This frees the insert member 406 to rotate about the receptacle longitudinal axis 606 so that axial position of the insert member 406 along the receptacle longitudinal axis 606 can be adjusted.

FIG. 12 is a closeup of the pin receptacle 612 showing the male threads 560 and the female threads 602. In the unlocked position 500, the entirety of the pin 410 lies inside the minor diameter 620 of the female threads 602, and therefore outside of the receptacle recess 610. Consequently, the insert member 406 is free to rotate within the female threads 602 of the receptacle 404.

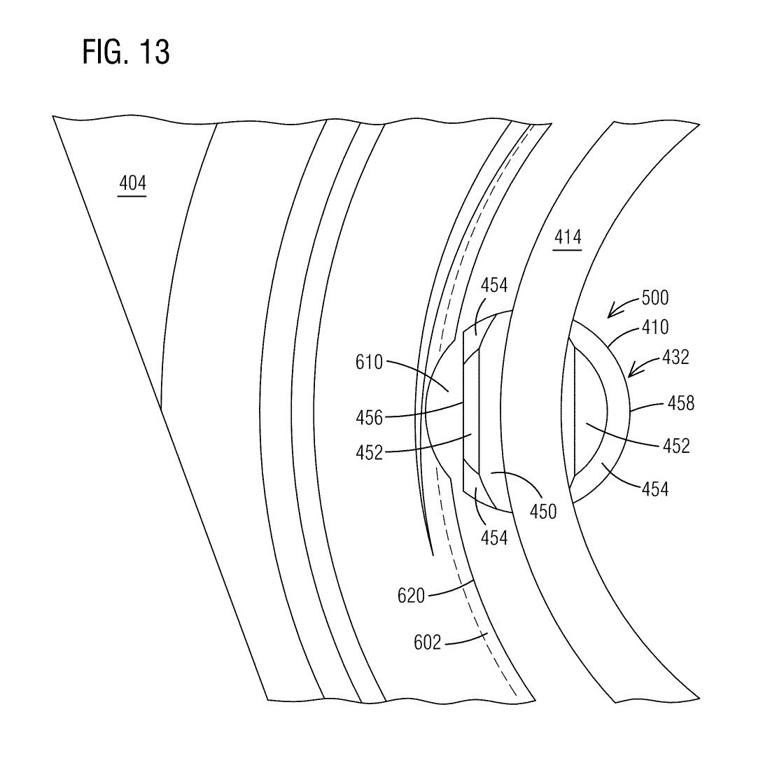

FIG. 13 is a bottom view of the fastener 300 of FIG. 12 with the pin 410 in the unlocked position, and with the insert member 406 removed for clarity. It can readily be seen that the entirety of the pin 410 is disposed within the minor diameter 620 of the female threads 602, thereby permitting the pin 410 and the insert member 406 to rotate about the receptacle longitudinal axis 606.

In addition, in the unlocked position the pin lock ring 414 rests on the land 450 (e.g. groove) between raised ridges 452. The cooperation of the land, 450, the raised ridges 452, and the wire of the pin lock ring 414 resist rotation of the pin 410 about the pin longitudinal axis 442. Consequently, once the pin 410 is in the unlocked position 500, it tends to stay in the unlocked position 500 unless forced out of it.

In alternate example embodiments, instead of the resilient member being a wire in the form of the pin lock ring 414, other shapes for the wire could be used, or another resilient element may be used. For example, a straight wire, or a flattened spring element could be used, and may occupy an appropriately-shaped recess in the insert member 406.

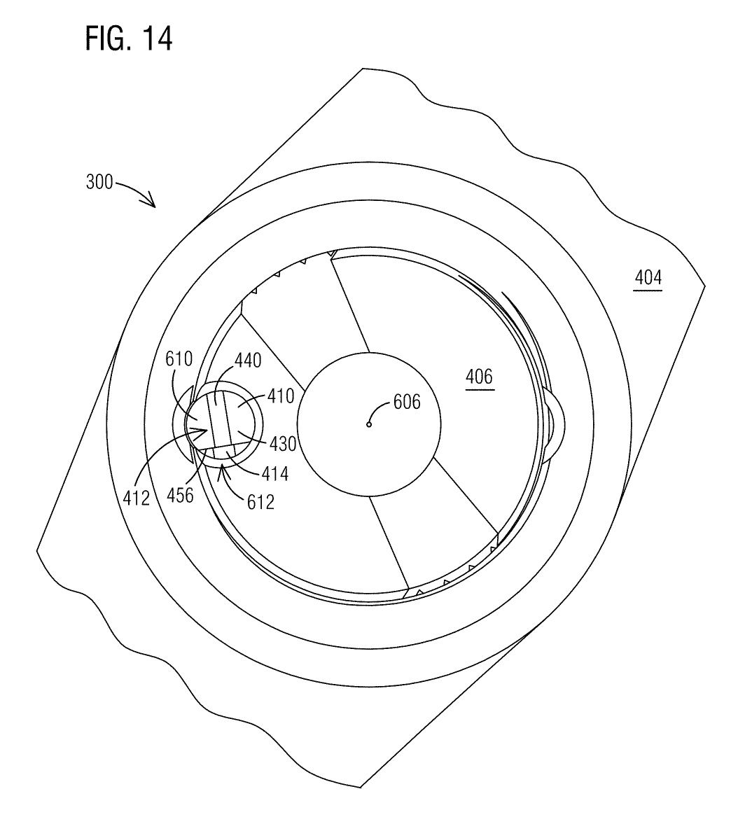

FIG. 14 is a top view of the fastener 300 where the pin is between the unlocked position 500 and a locked position. The entirety of the pin 410 is no longer limited to the insert member recess 412. Instead, the pin 410 occupies both the insert member recess 412 and the receptacle recess 610. In order to occupy the receptacle recess, at least part of the pin 410 must cross the minor diameter 620 of the female threads 602 of the receptacle 404, and a remainder crosses the male threads 560. When the pin 410 crosses both the female threads 602 and the male threads 560 like this, it creates an interference that prevents the male threads 560 from rotating relative to the female threads. Accordingly, in this configuration, the insert member 406 is not free to rotate about the receptacle longitudinal axis.

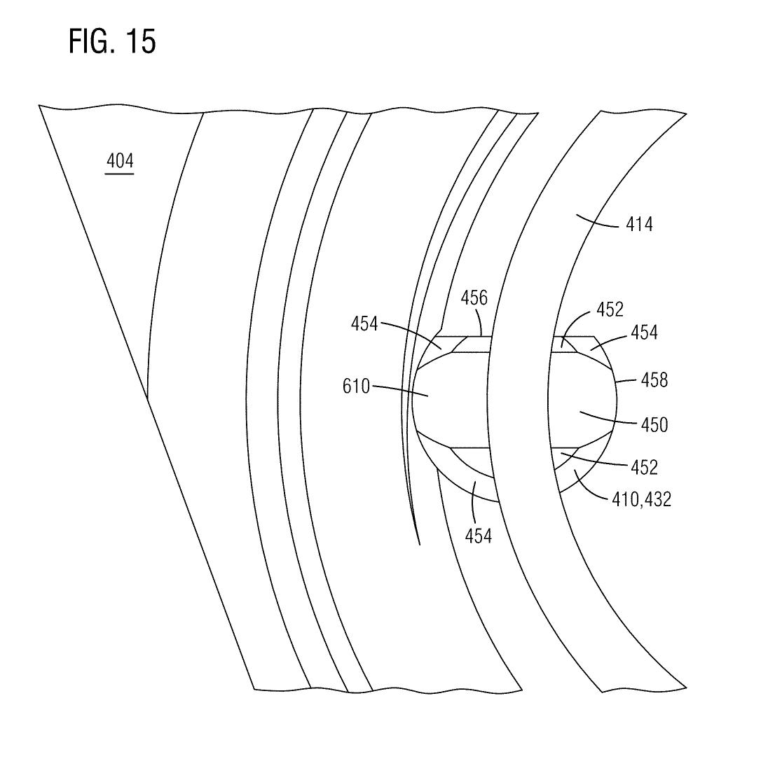

FIG. 15 is a bottom view of the fastener 300 of FIG. 14 with the pin 410 between the unlocked position 500 and a locked position, and with the insert member 406 removed for clarity. It can readily be seen that the pin 410 occupies both the insert member recess 412 and the receptacle recess 610, thereby preventing rotation of the insert member 406 in the receptacle 404. When between the unlocked position 500 and a locked position, depending on the amount of rotation about the pin longitudinal axis 442, and the associated amount of the receptacle recess 610 that is occupied by the pin 410, there may be a minor amount of relative rotational movement permitted.

In addition, when between the unlocked position 500 and a locked position, the pin lock ring no longer rests in the land 450 (e.g. groove), but instead rests atop the raised ridges 452. Once between the unlocked position 500 and a locked position, there is nothing beyond friction to prevent rotation of the pin 410 about the pin longitudinal axis 442. Consequently, it is easy to move the pin 410 from this position into the unlocked position 500 or the locked position.

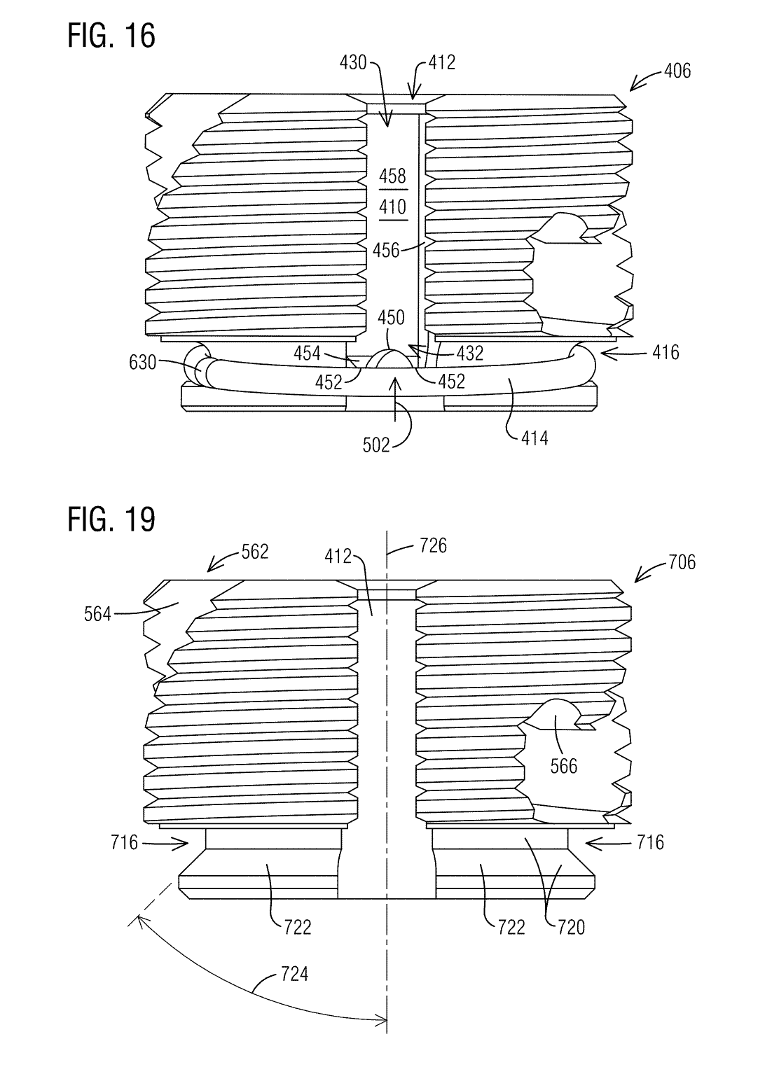

FIG. 16 is a side view of the insert member 406 and the pin lock ring 414 as displaced by the raised ridges 452 when the pin 410 is between the unlocked position 500 and a locked position. In this example embodiment, the pin lock ring 414 has been displaced downward and/or radially outward by the raised ridges 452. This displacement may be made possible by local deformation of the pin lock ring 414 and/or an increase in a size of a gap 630 in the pin lock ring 414. This deformation increases a force exerted by the pin lock ring 414 in the direction. This increase in force contributes to the resistance of the rotation of the pin 410 from the unlocked position 500 and the locked position. Chamfers 454 may be used to ramp the pin lock ring 414 from the land 450 to the raised ridge 452, thereby easing the transition from the unlocked position 500 and/or from the locked position.

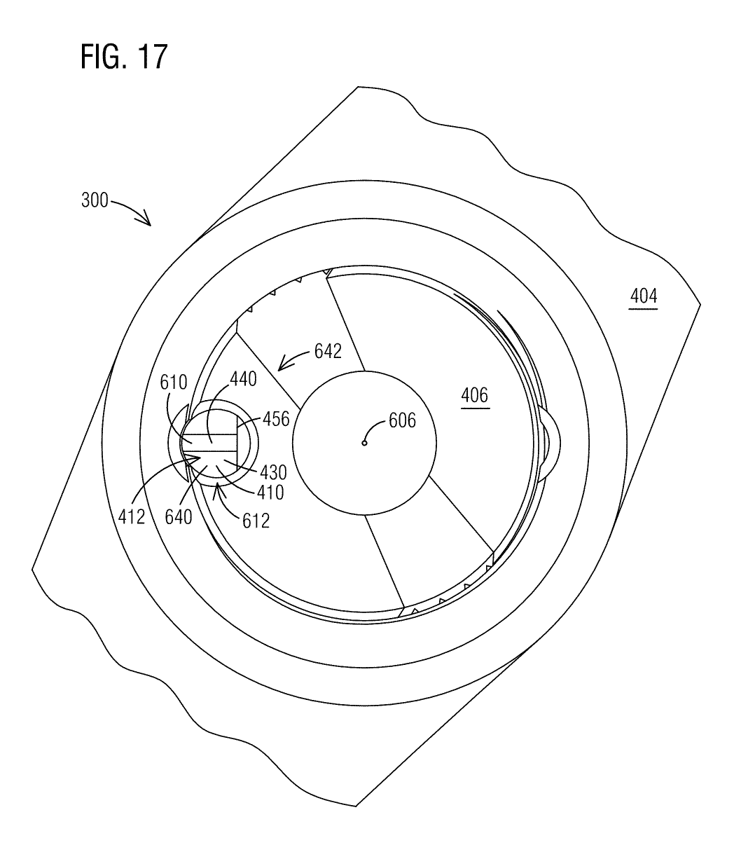

FIG. 17 is a top view of the fastener 300 with the pin 410 in the locked position 640 (e.g. a second position) which is 180 degrees about the pin longitudinal axis 442 from the unlocked position 500, and therefore the fastener 300 in a locked configuration 642. As with FIG. 14, the entirety of the pin 410 is no longer limited to the insert member recess 412. Instead, the pin 410 occupies both the insert member recess 412 and the receptacle recess 610. However, unlike FIG. 14, in the locked position, the pin 410 fully occupies the receptacle recess 610. This creates a maximum amount of interference, thereby minimizing relative rotation of the insert member 406 in either the clockwise or the counter clockwise direction about the receptacle longitudinal axis 606.

As indicated above, the pin 410 is not necessarily limited to a cylindrical shape with a flat surface as disclosed herein. Other suitable cross sections could include, for example, a “T” shape, where the upper surface of the cross-member of the “T” shape is akin to the flat surface 456. Further, the upper surface need not necessarily be flat. Suitable shapes enable rotation of the pin 410 within the pin receptacle 612, enable the entirety of the pin 410 to be disposed within the insert member recess 412 in one rotational/clocking position, and enable the pin 410 to be disposed within both the insert member recess 412 and the receptacle recess 610 in a second rotational/clocking position.

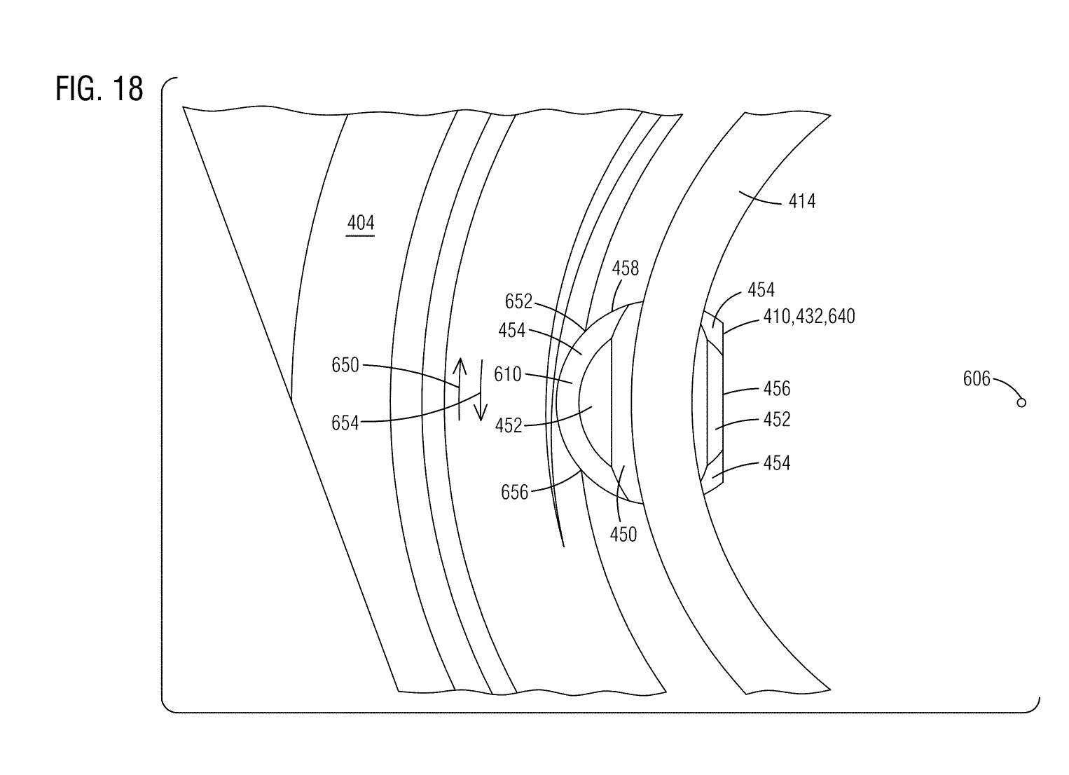

FIG. 18 is a bottom view of the fastener 300 of FIG. 17 with the pin 410 in the locked position 640, and with the insert member 406 removed for clarity. The pin 410 fully occupies the receptacle recess 610. Any attempt to rotate the insert member 406 about the receptacle longitudinal axis 606 in a clockwise direction 650 in FIG. 18 is immediately prevented by interference between the pin 410 and a first end 652 of the receptacle recess 610. Similarly, any attempt to rotate the insert member 406 about the receptacle longitudinal axis 606 in a counter clockwise direction 654 in FIG. 18 is immediately prevented by interference between the pin 410 and a second end 656 of the receptacle recess 610.

In addition, in the locked position 640 the pin lock ring 414 rests on the land 450 (e.g. groove) between raised ridges 452. The cooperation of the land, 450, the raised ridges 452, and the wire of the pin lock ring 414 resist rotation of the pin 410 about the pin longitudinal axis 442. Consequently, once the pin 410 is in the locked position 640, it tends to stay in the locked position 640 unless forced out of it.

FIG. 19 shows a side view of an alternate example embodiment of the insert member 706. In this example embodiment, the recess 716 includes a recess surface 720 which has a pronounced recess taper 722. The recess taper 722 makes it easier for the pin lock ring 414 to displace downward in response to rotations of the pin 410 from the unlocked position 500 or from the locked position 640 when compared to the lesser-tapered, or only filleted recess 416 shown in the example embodiment of FIG. 16. The recess taper 722 forms a taper angle 724 with an insert longitudinal axis 726. In an example embodiment, the taper angle 724 is the same about the entire circumference of the recess 716. In an alternate example embodiment, the taper angle 724 may vary. For example, the taper angle 724 may decrease at circumferential locations proximate the insert member recess 412. This local increase in the taper angle 724 will coincide with a location of the pin lock ring 414 that is deflected farthest downward, while not interfering with the ability of the recess 716 to retain the pin lock ring 414 therein.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A fastener for holding together a first panel and a second panel, wherein each panel comprises a respective aperture configured to receive the fastener, first sides of each panel facing each other, and second sides facing away from each other, the fastener comprising:
a grommet comprising a flange and an opening there through, an underside of the flange configured to engage the second side of the first panel;
an elongated pin characterized by a pin longitudinal axis along its length;
a receptacle mounted to the first side of the second panel and comprising a central opening configured to face the first side of the first panel and to align with the aperture of the first panel, the receptacle comprising female threads;
an insert member comprising two ramped bayonet slot arrangements each configured to engage cross pins of a stud inserted through the grommet, and male threads; and
a pin receptacle formed partly by a recess in the female threads and partly in the insert member when the receptacle and the insert member align, the pin receptacle configured to receive the pin and permit the pin to rotate therein about the pin longitudinal axis,
wherein in a first position the pin does not occupy the recess in the female threads, thereby permitting relative rotation between the receptacle and the insert member, and
wherein in a second position the pin occupies the recess, thereby preventing the relative rotation between the receptacle and the insert member.

2. The fastener of claim 1, the pin further comprising an eccentricity that is rotated into the recess in the second position and out of the recess in the first position.

3. The fastener of claim 1, the pin receptacle further comprising a lip configured to retain the pin therein.

4. The fastener of claim 3, further comprising a resilient member configured to exert a force on an end of the pin via a bias of the resilient member, thereby urging the pin into the pin receptacle and against the lip.

5. The fastener of claim 4, further comprises a pin lock ring, and the insert member further comprises an annular groove configured to receive and position the pin lock ring against the end of the pin to create the force.

6. The fastener of claim 5, the pin further comprising a raised ridge, wherein rotation of the pin out of the first position or out of the second position displaces the pin lock ring onto the raised ridge against the bias, thereby creating a rotational interference that resists the rotation of the pin.

7. The fastener of claim 6, wherein the annular groove comprises a taper against along which the pin lock ring is displaced during the rotation of the pin.

8. The fastener of claim 6, further comprising a pin groove, wherein when in the first position or in the second position the pin groove aligns with and receives the pin lock ring therein.

9. The fastener of claim 1, the pin further comprising a tool recess configured to receive a tool used to rotate the pin.

10. A fastener for holding together a first panel and a second panel, wherein each panel comprises a respective aperture configured to receive the fastener, first sides of each panel facing each other, and second sides facing away from each other, the fastener comprising:
a grommet comprising a flange and an opening there through, an underside of the flange configured to engage the second side of the first panel;
an elongated pin characterized by a pin longitudinal axis along its length;
a receptacle mounted to the first side of the second panel and comprising a central opening configured to face the first side of the first panel and to align with the aperture of the first panel, the receptacle comprising female threads and a receptacle recess; and
an insert member comprising cam and locking surfaces configured to engage cross pins of a stud inserted through the grommet, male threads, and an insert member recess;
wherein when the insert member is in a first clocking position with respect to the receptacle the receptacle recess and the insert member recess align and together form a pin receptacle configured to receive and permit the pin to rotate therein about the pin longitudinal axis;
wherein when the pin is in a first pin clocking position about the pin longitudinal axis relative to the insert member the pin resides entirely in the insert member recess, thereby permitting relative rotation between the receptacle and the insert member, and
wherein when the receptacle and the insert member align to form the pin receptacle, when in a second clocking position about the pin longitudinal axis the pin occupies the receptacle recess thereby preventing the relative rotation between the receptacle and the insert member.

11. The fastener of claim 10, further comprising a resilient member configured to urge the pin into the pin receptacle.

12. The fastener of claim 11, the resilient member comprising a wire configured to abut an end of the pin and create a force that urges the pin into the pin receptacle via a bias of the wire.

13. The fastener of claim 12, the insert member further comprising a recess configured to receive the wire and hold the wire against the end of the pin, thereby creating the force.

14. The fastener of claim 13, wherein the wire comprises a pin lock ring, and wherein the insert member further comprises an annular groove configured to receive the pin lock ring.

15. The fastener of claim 14, the pin comprising a land and a raised ridge disposed on the end against which the wire abuts, wherein when the pin is in the first pin clocking position or the second clocking position the wire rests in the land and is held in place by a rotational interference between the wire and the raised ridge, and wherein when the pin is between the first clocking position or the second clocking position the wire is displaced to a position atop the raised ridge, thereby increasing the force.

16. The fastener of claim 15, wherein the annular groove comprises a taper against which the pin lock ring is displaced when the wire is displaced to the position atop the raised ridge.

17. The fastener of claim 10, the pin receptacle further comprising a lip configured to retain the pin therein.

18. The fastener of claim 10, the pin further comprising a tool recess configured to receive a tool used to rotate the pin.

19. A fastener for holding together a first panel and a second panel, wherein each panel comprises a respective aperture configured to receive the fastener, first sides of each panel facing each other, and second sides facing away from each other, the fastener comprising:
a grommet comprising a flange and an opening there through, an underside of the flange configured to engage the second side of the first panel;
an elongated pin comprising ends and a side spanning the ends, the side comprising a curved surface and a flat surface, the elongated pin characterized by a pin longitudinal axis along its length;
a receptacle mounted to the first side of the second panel and comprising a central opening configured to face the first side of the first panel and to align with the aperture of the first panel, the receptacle comprising female threads and a receptacle recess; and
an insert member comprising cam and locking surfaces configured to engage cross pins of a stud inserted through the grommet, male threads, and an insert member recess;
wherein when the insert member is in a first clocking position with respect to the receptacle the receptacle recess and the insert member recess align and together form a pin receptacle configured to receive and permit the pin to rotate therein about the pin longitudinal axis;
wherein when the pin is in an unlocked position about the pin longitudinal axis relative to the insert member the curved surface resides entirely in the insert member recess and the flat surface faces the receptacle recess, thereby permitting relative rotation between the receptacle and the insert member, and
wherein when the receptacle and the insert member align to form the pin receptacle, when in a locked position about the pin longitudinal axis the curved surface occupies the insert member recess and the receptacle recess thereby preventing the relative rotation between the receptacle and the insert member.
